(19) United States
(12) Patent Application Publication
(10) Pub. No.: US 2025/0121506 A1
(43) Pub. Date: Apr. 17, 2025

(54) PROGRAMMING APPARATUS

(71) Applicant: FANUC CORPORATION, Yamanashi (JP)

(72) Inventor: Daiki HAYASHI, Yamanashi (JP)

(21) Appl. No.: 18/730,307

(22) PCT Filed: Feb. 1, 2022
(86) PCT No.: PCT/JP2022/003829

§ 371 Date: Jul. 19, 2024

(51) Int. Cl. B25J 13/06; B25J 9/16

(52) U.S. Cl. CPC B25J 13/06; B25J 9/163

(57) ABSTRACT

An object is to achieve simulation-type off-line teaching which is not time-consuming. A programming apparatus 1 according to one aspect of the present disclosure is a programming apparatus for teaching a motion program of a robot off-line, which includes an operation unit 3, a display unit 4 configured to display a 3D model of the robot so as to repeat movement and stop in accordance with a user operation on the operation unit, a recording unit 26 configured to record a plurality of teaching candidate points one after another in accordance with the stop of the 3D model, a teaching point registration unit 27 configured to register, as teaching points, a plurality of teaching candidate points selected from the plurality of recorded teaching candidate points in accordance with a user instruction, and a creation unit 28 configured to create the motion program based on the plurality of registered teaching points.

### RELATED APPLICATIONS

The present application is a National Phase of International Application No. PCT/JP2022/003829 filed Feb. 1, 2022.

### TECHNICAL FIELD

This disclosure relates to a programming apparatus.

### BACKGROUND ART

As a method for teaching a predetermined motion to a robot, methods such as an on-line teaching method, an off-line teaching method have been proposed. For example, a teaching method based on a teaching playback method is known as an on-line teaching method (Patent Literature 1). On the other hand, as an off-line teaching method, there is a teaching method based on a simulation method. Off-line teaching based on a simulation method is widely used because it can create 3D models of a robot, an end effector, a workpiece, a peripheral device, and the like, and create a motion program while operating the entire system in a virtual space displayed on a personal computer so that the actual machine need not be operated.

However, in simulation-type off-line teaching, it is necessary to operate a virtual teaching operation panel displayed on a computer in the same manner as in on-line teaching. Specifically, an operation of moving a robot model to a teaching position and an operation of registering the teaching position are required. In addition, every time a teaching position is registered, an operation of inputting motion conditions such as a motion speed, an interpolation format, and a movement format is required. Such operations of the teaching operation panel are very time-consuming. In addition, since the robot model and the teaching operation panel need to be displayed on the screen, the robot model must be displayed in a small size, making it difficult to confirm the robot model, which also increases the time and effort required to operate the teaching operation panel.

### CITATION LIST

### Patent Literature

Patent Literature 1: Japanese Unexamined Patent Application Publication No. 09-062335

### BRIEF DESCRIPTION OF THE DRAWINGS

FIG. 1 is a functional block diagram of a programming apparatus according to the present embodiment.

FIG. 2 shows an example of a teaching screen when a teaching position displayed on a display unit of the programming apparatus shown in FIG. 1 is manually registered.

FIG. 3 shows an example of a teaching screen when a teaching position displayed on the display unit of the programming apparatus shown in FIG. 1 is automatically registered.

FIG. 4 shows an example of an editing screen displayed on the display unit of the programming apparatus shown in FIG. 1.

FIG. 5 is a flow chart showing an example of a procedure for creating a motion program by the programming apparatus shown in FIG. 1.

### DETAILED DESCRIPTION OF THE INVENTION

A programming apparatus according to one aspect of the present disclosure is a programming apparatus for teaching a motion program of a robot off-line, which includes an operation unit, a display unit configured to display a 3D model of the robot so as to repeat movement and stop in accordance with a user operation on the operation unit, a recording unit configured to record a plurality of teaching candidate points one after another in accordance with the stop of the 3D model, a teaching point registration unit configured to register, as teaching points, a plurality of teaching candidate points selected from the plurality of recorded teaching candidate points in accordance with a user instruction, and a creation unit configured to create the motion program based on the plurality of registered teaching points.

Hereinafter, a programming apparatus according to the present embodiment will be described with reference to the drawings. The programming apparatus according to the present embodiment is mainly used to teach a motion program while utilizing motion simulation of a robot apparatus. In the present embodiment, a motion program for causing a robot apparatus in which a hand is attached to a wrist of a robot arm mechanism to perform workpiece picking work is taught. In the following description, constituent elements having substantially the same function and configuration are denoted by the same reference numeral, and repetitive descriptions will be given only where necessary.

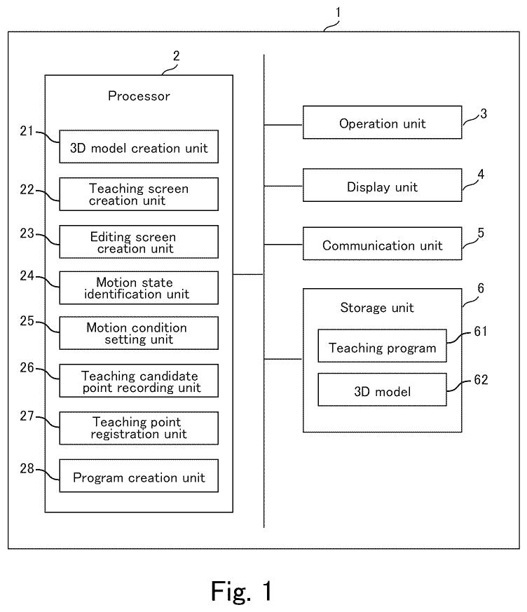

As shown in FIG. 1, a programming apparatus 1 according to the present embodiment is configured by connecting hardware such as an operation unit 3, a display unit 4, a communication unit 5, and a storage unit 6 to a processor 2 (such as a CPU). The programming apparatus 1 is provided by a general information processing terminal such as a personal computer or a tablet.

The operation unit 3 includes an input device such as a keyboard, a mouse, and a jog. Note that a touch panel or the like that serves as both the operation unit 3 and the display unit 4 may be used. The user can input various types of information into the programming apparatus 1 through the operation unit 3. The various types of information include selection information relating to the teaching mode, the interpolation format, and the movement format, input information of the program name and the motion speed, and operation information of the robot apparatus displayed on the teaching screen. The interpolation format is a condition relating to the interpolation format between two teaching points. For example, the interpolation format “Joint” indicates performing interpolation so as not to apply a load to each joint of the robot apparatus. The interpolation format includes other interpolation formats such as linear interpolation. The movement format is a condition relating to how to move the robot apparatus between a plurality of teaching points. For example, the movement format “FINE” indicates moving the robot apparatus so that it always passes through the teaching points. The movement form “CNT” indicates that the robot apparatus does not necessarily have to pass through the teaching points, but is moved smoothly so as to pass through or near the teaching points. The motion speed is expressed as a percentage of a predefined maximum speed. For example, the motion speed “100%” indicates that the robot apparatus is moved at the maximum speed.

The display unit 4 includes a display device such as an LCD. The display unit 4 displays a teaching screen created by a teaching screen creation unit 22, an editing screen created by an editing screen creation unit 23, and the like.

The storage unit 6 includes a storage device such as an HDD or an SSD. Teaching programs 61 and data of 3D models 62 are stored in advance in the storage unit 6. The data of 3D models 62 include 3D model data of the robot apparatus and 3D model data of the workpiece. The data of 3D models 62 are provided by CAD data. In the description herein, a 3D model of a robot apparatus may be simply referred to as a robot apparatus, and a 3D model of a workpiece may be simply referred to as a workpiece.

The storage unit 6 stores various types of information generated in the process of automatically registering teaching candidate points. For example, the various types of information include information on the settings of a motion program such as the program name, the interpolation format, the motion speed, and the movement format, information on a plurality of teaching candidate points recorded by a teaching candidate point recording unit 26 to be described later, and information on a plurality of teaching points registered by a teaching point registration unit 27.

The communication unit 5 controls transmission and reception of data to and from a robot controller. For example, the motion program created by the programming apparatus 1 is provided to the robot controller by the processing of the communication unit 5.

When the processor 2 executes the teaching program 61 stored in the storage unit 6, the programming apparatus 1 functions as a 3D model creation unit 21, the teaching screen creation unit 22, the editing screen creation unit 23, a motion state identification unit 24, a motion condition setting unit 25, the teaching candidate point recording unit 26, the teaching point registration unit 27, and a program creation unit 28.

The 3D model creation unit 21 creates 3D models of the robot apparatus and the workpiece, using the data of 3D models 62 stored in the storage unit 6.

The teaching screen creation unit 22 creates a teaching screen for teaching the motion program of the robot apparatus off-line. Details of the teaching screen will be described later.

The editing screen creation unit 23 creates an editing screen for receiving operations for selecting a plurality of teaching points to be actually used in the motion program from a plurality of teaching candidate points recorded by the teaching candidate point recording unit 26 and for correcting the motion conditions. Details of the editing screen will be described later.

The motion state identification unit 24 identifies the motion state of the robot apparatus. On the teaching screen, the robotic apparatus can be moved on a simulation area 110 in accordance with user operations. A plurality of commands for moving the robot apparatus are assigned to a plurality of types of operations through the operation unit 3. The motion state identification unit receives an input of a user operation from the operation unit 3 and identifies that the robot apparatus has started to move and that the robot apparatus has shifted from a moving state to a stopped state in accordance with the input of a command for moving the robot apparatus. Here, the stopped state refers to a state in which a command for moving the robot apparatus has not been input through the operation unit 3 for a predetermined elapsed time. This elapsed time can be arbitrarily changed in accordance with a user instruction.

The motion condition setting unit 25 sets the interpolation format, movement format, program name, and motion speed input through the operation unit 3 as motion conditions.

The teaching candidate point recording unit 26 records the position of a hand reference point and the hand posture of the robot apparatus as a teaching candidate point in the storage unit 6 at the timing when the motion state identification unit 24 identifies that the robot apparatus has shifted from the moving state to the stopped state. The teaching candidate point includes information on the position of the hand reference point and information on the hand posture. The position of the hand reference point is set at a midway position between a pair of fingers of the robot hand. The position of the hand reference point is represented by a position (X, Y, Z) on three orthogonal axes in a virtual space, and the hand posture is represented by rotation angles (W, P, R) around the respective axes.

The teaching point registration unit 27 registers in the storage unit 6 as a teaching point a teaching candidate point selected from among the plurality of teaching candidate points recorded by the teaching candidate point recording unit 26 in accordance with a user operation on the editing screen.

The program creation unit 28 creates a motion program based on the motion conditions set by the motion condition setting unit 25 and a plurality of teaching points registered by the teaching point registration unit 27.

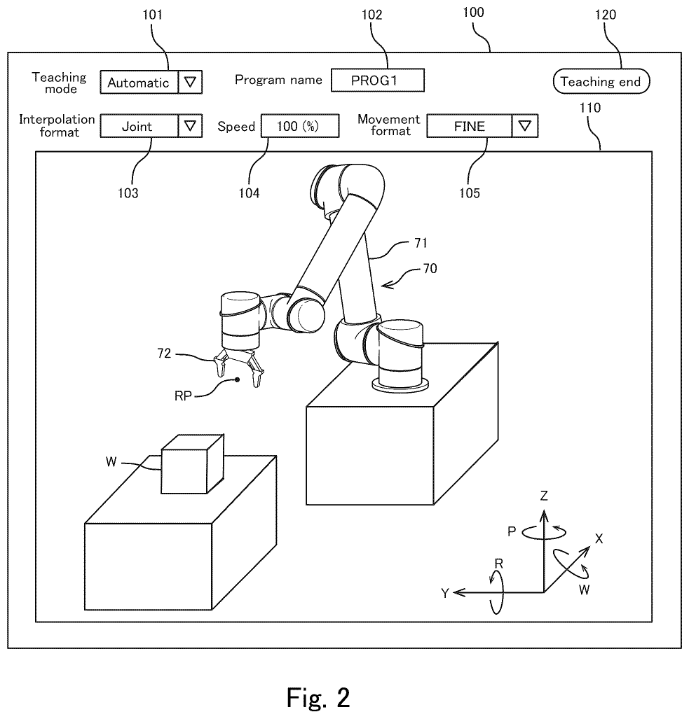

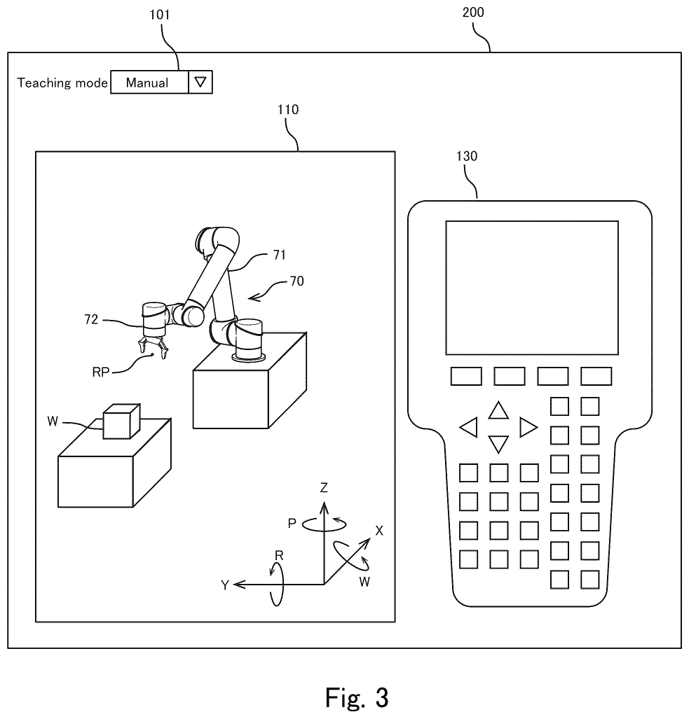

The teaching screen created by the teaching screen creation unit 22 will be described below with reference to FIG. 2 and FIG. 3. FIG. 2 and FIG. 3 show examples of the teaching screen. As shown in FIG. 2 and FIG. 3, the teaching screen 100, 200 includes a pull-down menu 101 for switching the teaching mode. The pull-down list of the teaching mode includes a “manual mode” in which each teaching position is manually registered by the user, and an “automatic mode” in which teaching positions are automatically registered one after another.

FIG. 2 shows an example of the teaching screen 100 (referred to as an automatic teaching screen 100) when the “automatic mode” is selected as the teaching mode. As shown in FIG. 2, the automatic teaching screen 100 includes a plurality of input fields 102 and 104 for receiving inputs of a program name and a motion speed of the robot apparatus, and a plurality of pull-down menus 103 and 105 for receiving inputs of an interpolation format and a movement format. As described above, the automatic teaching screen 100 is configured to collectively receive various motion conditions necessary for creating a motion program.

In addition, the automatic teaching screen 100 includes a simulation area 110 for displaying a virtual space in which a robot apparatus 70 and a workpiece W are arranged. In the simulation area 110, 3D models of the robot apparatus 70, which is a robot arm mechanism 71 provided with a robot hand 72 at the wrist, and the workpiece W, which are created by the 3D model creation unit 21, are displayed two-dimensionally. The positions and postures of the robot apparatus 70 and the workpiece W displayed in the simulation area 110 can be changed by a user operation through the operation unit 3. For example, when a mouse is used for operation, the hand reference point RP of the robot apparatus 70 can be moved to a desired position with the hand reference point RP selected. In addition, the hand reference point RP of the robot apparatus 70 can be changed to a desired orientation by a predetermined operation on the simulation area 110. As described above, the automatic teaching screen 100 is configured such that the user can directly operate the robot apparatus 70 through the operation unit 3. The automatic teaching screen 100 displays a teaching end button 120 for receiving the end of teaching of the robot apparatus 70 displayed in the simulation area 110.

FIG. 3 shows the teaching screen 200 (referred to as an manual teaching screen 200) when the “manual mode” is selected as the teaching mode. As shown in FIG. 3, the manual teaching screen 200 includes a simulation area 110 similar to that in the automatic teaching screen 100. On the other hand, as a configuration different from the automatic teaching screen 100, the manual teaching screen 200 displays a teaching operation panel 130 for receiving inputs of a program name, a motion speed of the robot apparatus, an interpolation format, and a movement format, and the moving operation of the robot apparatus.

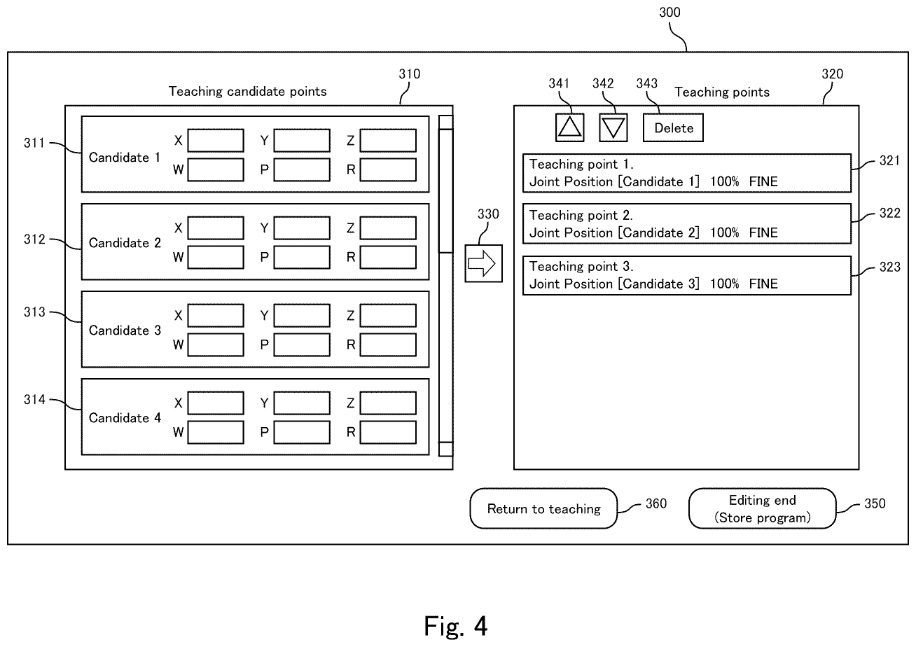

The editing screen created by the editing screen creation unit 23 will be described below with reference to FIG. 4. FIG. 4 shows an example of the editing screen. As shown in FIG. 4, the editing screen 300 includes a teaching candidate point display area 310 located on the left side, a teaching point display area 320 located on the right side, and a selection button 330 located therebetween. In the teaching candidate point display area 310, a list of a plurality of teaching candidate points 311, 312, 313, and 314 aligned according to the recorded order is displayed. In the teaching point display area 320, a list of a plurality of teaching points 321, 322, and 323 aligned according to the motion order is displayed. The user can select specific teaching candidate points from a plurality of teaching candidate points 311, 312, 313, and 314 and click the selection button 330 so as to register the specific teaching candidate points. The order of registered teaching points can be changed by operating buttons 341 and 342. In addition, the registered teaching points can be deleted by operating a delete button 343. Furthermore, the motion conditions can be changed arbitrarily by selecting a teaching point. On the editing screen 300, an editing end button 350 for receiving the end of editing and a button 360 for returning to the automatic teaching screen 100 for resuming teaching are displayed.

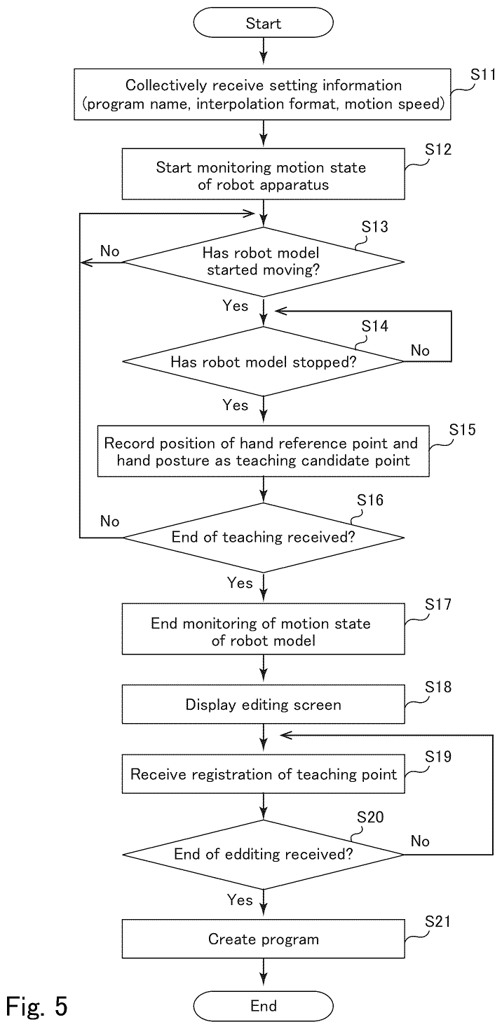

The process of automatically registering teaching points will be described below with reference to FIG. 5. It is assumed that the automatic teaching screen 100 as shown in FIG. 2 is displayed on the programming apparatus 1.

The programming apparatus 1 collectively receives the program name, interpolation format, motion speed, and movement format input in accordance with user operations on the teaching screen (S11). In addition, the programming apparatus 1 starts monitoring of the motion state of the robot apparatus 70 displayed on the automatic teaching screen 100 (S12). The programming apparatus 1 waits until a user operation on the robot apparatus 70 through the operation unit 3 is received (S13; NO). When a user operation on the robot apparatus 70 through the operation unit 3 is received and the robot apparatus 70 starts to move (S13; YES), the recording of teaching candidate points is waited until there is no user operation on the robot apparatus 70 for a certain period of time and the robot apparatus 70 stops (S14; NO). When there is no user operation on the robot apparatus 70 for the certain period of time and the motion of the robot apparatus 70 is stopped (S14; YES), the position of the hand reference point RP and the hand posture of the robot apparatus 70 at that time are recorded as a teaching candidate point (S15). The processes of steps S13 to S15 are repeatedly executed until the end of teaching (step S16; NO). Here, the end of teaching is triggered by the teaching end button 120 being clicked or the teaching mode being switched. When the teaching is ended (S16; YES), the monitoring of the motion state of the robot apparatus 70 is ended (S17), and the editing screen 300 as shown in FIG. 4 is displayed (S18). Then, a process of registering a teaching point is received through a user operation on the editing screen 300 (S19). The registration of a teaching point by the user is repeated until the editing is ended (S20; NO). When the editing is ended (S20; YES), a motion program is created based on the plurality of teaching points registered in step S19 and the motion conditions received in step S11 (S21), and the created motion program is saved with the program name received in step S11.

According to the programming apparatus 1 of the present embodiment, the following effects are obtained. That is, each time the motion of the robot apparatus 70 displayed on the automatic teaching screen 100 is stopped, the position of the hand reference point RP and the hand posture at the time of stop can be recorded one after another as a teaching candidate point. In order to record the position of the hand reference point RP and the hand posture as a teaching candidate point, the robot apparatus 70 only needs to be stopped, and no special operation, such as a button operation, for recording it is required. The user only needs to perform an operation to move the robot apparatus 70, and the time and effort required to teach the motion program can be saved.

In addition, various motion conditions necessary for creating the motion program can be collectively received by user operations through the operation unit 3 on respective input fields and pull-down menus displayed on the automatic teaching screen 100. This allows the user to perform operations through the operation unit 3, such as a mouse operation and a jog operation, on the robot apparatus without worrying about the movement, speed, and path between teaching points.

In this way, the motion conditions necessary for creating the motion program are collectively received, and the teaching positions are automatically recorded, eliminating the need to display the teaching operation panel 130 as shown in the manual teaching screen 200 of FIG. 3. As shown in the automatic teaching screen 100 of FIG. 2, the simulation area 110 can be wide, and the robot apparatus 70 can be displayed in a large size. Accordingly, the position and posture of the robot apparatus 70 can be easily confirmed, operation errors that occur because the robot apparatus 70 is small and difficult to confirm can be reduced, and the stress of operating the robot apparatus 70 can be reduced. As a result, the time and effort for teaching the motion program of the robot apparatus 70 can be reduced.

Further, even if the position of the hand reference point RP or the hand posture of the robot apparatus 70 are incorrectly recorded as a teaching candidate point, it is only necessary not to register the incorrectly recorded teaching candidate point as a teaching point by a user operation on the editing screen 300 after teaching. Therefore, at the time when the position of the hand reference point RP and the hand posture are incorrectly recorded as a teaching candidate point, it is not necessary to perform an operation to delete the incorrectly recorded teaching candidate point, and the operation to the robot apparatus 70 on the automatic teaching screen 100 can be continued without interruption. As described above, by dividing the teaching phase into two phases, one for inputting the motion conditions necessary for creating the motion program on the automatic teaching screen 100 and recording the candidate teaching points, and the other for editing the input motion conditions and recorded candidate teaching points, the work of recording the teaching positions and the work of editing the teaching positions do not need to be repeated, and as a result, the motion program can be taught efficiently.

In the present embodiment, the position and orientation of the hand reference point RP of the robot apparatus 70 at the time when the robot apparatus 70 is shifted from the moving state to the stopped state are recorded as a teaching candidate point. However, as long as the teaching candidate point can be automatically recorded while the user operates the robot apparatus 70 displayed in the simulation area 110, the trigger is not limited to the stop of the robot apparatus 70. For example, the point in time when there has been no user operation on the simulation area 110 for a certain period of time or no user operation on the automatic teaching screen 100 for a certain period of time may be used as the trigger for recording a candidate teaching point. Further, a command for recording a teaching candidate point may be assigned to a specific operation through the operation unit 3 so that the teaching candidate point can be recorded manually.

In the present embodiment, the position and orientation of the hand reference point RP of the robot apparatus 70 are recorded as a teaching candidate point. However, as long as the teaching candidate point can be uniquely identified, the position of the reference point to be recorded is not limited to the hand reference point. For example, the position and orientation of a predetermined point on the robot apparatus 70 may be recorded as a teaching candidate point.

In the editing screen 300 displayed on the programming apparatus 1 according to the present embodiment, the teaching candidate points are indicated by coordinates (X, Y, Z, W, P, R). However, the display mode of the teaching candidate points is not limited to the present embodiment. For example, a plurality of teaching candidate points may be displayed to overlap a virtual space including the robot apparatus 70 displayed in the simulation area 110 of the automatic teaching screen 100 with matching positions and orientations. In this case, it is desirable that the teaching candidate points selected and those not selected as the teaching points are distinguished when displayed.

The programming apparatus 1 according to the present embodiment has, in order to save the user's time and effort, a function of collectively receiving motion conditions on the teaching screen 100, a function of automatically recording teaching candidate points only by operating the robot apparatus 70 on the teaching screen 100, and a function of receiving operations of selecting teaching candidate points to be registered as teaching points from the teaching candidate points in the editing work on the editing screen 300 displayed after the teaching work. However, from the viewpoint of saving the user's time and effort only, the programming apparatus may be configured to have only one of the above functions. Further, the controller that controls the robot may have the functions of the programming apparatus.

In addition, each function of the programming apparatus 1 according to the present embodiment can be used to save the user's time and effort in on-line teaching such as direct teaching using an actual machine. For example, in direct teaching, by registering the positions at which the robot apparatus actually stops as teaching candidate points or teaching points, the operations for registering the positions as teaching candidate points or teaching points can be eliminated and the user's time and effort in direct teaching can be saved. Similarly, by collectively receiving the motion conditions, the user can perform the operation of moving the robot apparatus in direct teaching without worrying about the operation speed and the operation path.

While some embodiments of the present invention have been described, these embodiments have been presented as examples, and are not intended to limit the scope of the invention. These embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

1. A programming apparatus for teaching a motion program of a robot off-line, comprising:
an operation unit;
a display unit configured to display a 3D model of the robot so as to repeat movement and stop in accordance with an operation by a user on the operation unit;
a recording unit configured to record a plurality of teaching candidate points one after another in accordance with the stop of the 3D model;
a teaching point registration unit configured to register, as teaching points, a plurality of teaching candidate points selected from the plurality of recorded teaching candidate points in accordance with an operation by the user; and
a creation unit configured to create the motion program based on the plurality of registered teaching points.

2. The programming apparatus according to claim 1, further comprising:
a setting unit configured to collectively set an interpolation format and a moving speed between the plurality of teaching points in accordance with an operation by the user, wherein
the creation unit creates the motion program based on the interpolation format and the moving speed together with the plurality of registered teaching points.

3. The programming apparatus according to claim 2, wherein
the setting unit sets a name of the motion program in accordance with an instruction of the user.

4. The programming apparatus according to claim 1, wherein
the display unit displays a list of the plurality of recorded teaching candidate points, and the user selects the plurality of teaching points from the plurality of teaching candidate points displayed in the list.

5. The programming apparatus according to claim 1, wherein
the display unit displays the plurality of recorded teaching candidate points so as to overlap the 3D model, and the user selects the teaching points from the plurality of teaching candidate points overlapping the 3D model.
